(19) United States
(12) Patent Application Publication
(10) Pub. No.: US 2008/0181760 A1
(43) Pub. Date: Jul. 31, 2008

(54) FORK ATTACHMENT

(75) Inventors: Jeffry R. Frahm, Frankenmuth, MI (US); Nicholas J. Mehl, Essexville, MI (US)

Correspondence Address: REISING, ETHINGTON, BARNES, KISSELLE, P.C., P O BOX 4390, TROY, MI, 48099-4390, US

(73) Assignee: Magline, Inc., Pinconning, MI (US)

(21) Appl. No.: 12/016,310

(22) Filed: Jan. 18, 2008

Related U.S. Application Data
(60) Provisional application No. 60/886,799, filed on Jan. 26, 2007.

(51) Int. Cl. B66C 3/00

(52) U.S. Cl. 414/785

(57) ABSTRACT

A fork attachment that can be used with a fork of a material handling device to handle a load may include a body and a head. The body is constructed to be carried by the fork, and the head is constructed to engage the load. The head is mounted to the body so that the head rotates about the body to engage the load if and when the load is initially misaligned with respect to the head such as when load has an angled base or when the ground beneath the load is uneven.

### REFERENCE TO CO-PENDING APPLICATION

This application claims the benefit of, and incorporates by reference in its entirety, U.S. Provisional Application Ser. No. 60/886,799, filed Jan. 26, 2007.

### FIELD OF THE INVENTION

The present invention relates generally to material handling, and more particularly to the use of forked material handling devices such as forklifts for handling loads such as carts.

### BACKGROUND OF THE INVENTION

Material handling devices like forklifts, pallet jacks, and walkie-riders are often equipped with forks for lifting and moving loads that otherwise are difficult to handle because of their bulk or shape. But sometimes the forks alone are unfit to handle all loads in all situations, and so an attachment or adaptor is needed to suit the forks to the particular situation. For example, sometimes the loads can have an angled base or sometimes the ground beneath the load can be uneven by being slanted, having potholes, and the like.

### SUMMARY OF THE INVENTION

One embodiment of a fork attachment that is used with a fork of a material handling device in order to handle a load may include a body constructed to be carried by the fork, and may include a head. The head is constructed to engage the load, and may be mounted to the body so that the head can rotate or pivot about the body in order to engage the load if and when the load is initially misaligned with respect to the head.

One embodiment of a fork attachment that is carried by a fork of a material handling device in order to handle a load may include a body, at least one pin, a head, and a first pin. The at least one pin mounts the body to the fork and may mate in a socket that is defined in the fork in order to allow the fork attachment to pivot with respect to a fork axis. The head may have at least one hook that engages the load. The first pin may mount the head to the body so that the head can rotate about the first pin.

One embodiment of a fork attachment may include a body, at least one pin, a head, a first pin, at least one bolt, and a stop. The at least one pin may mount the body to a fork and may allow the fork attachment to pivot. The head may have at least one hook. The first pin may mount the head to the body and may allow the head to rotate with respect to the body. The at least one bolt may limit the rotating movement of the head. The stop may limit the pivoting movement of the fork attachment.

### BRIEF DESCRIPTION OF THE DRAWINGS

The following detailed description of preferred implementations and best mode will be set forth with regard to the accompanying drawings in which:

FIG. 1 is a perspective view of an embodiment of an attachment carried by a fork as the fork approaches a load;

FIG. 2 is a top view of the attachment of FIG. 1;

FIG. 3 is a side view of the attachment of FIG. 1;

FIG. 4 is a front view of the attachment of FIG. 1;

FIG. 5 is a fragmented sectional view taken along line 5-5 in FIG. 2; and

FIG. 6 is a fragmented side view of the attachment and the fork of FIG. 1.

### DETAILED DESCRIPTION OF PREFERRED EMBODIMENTS

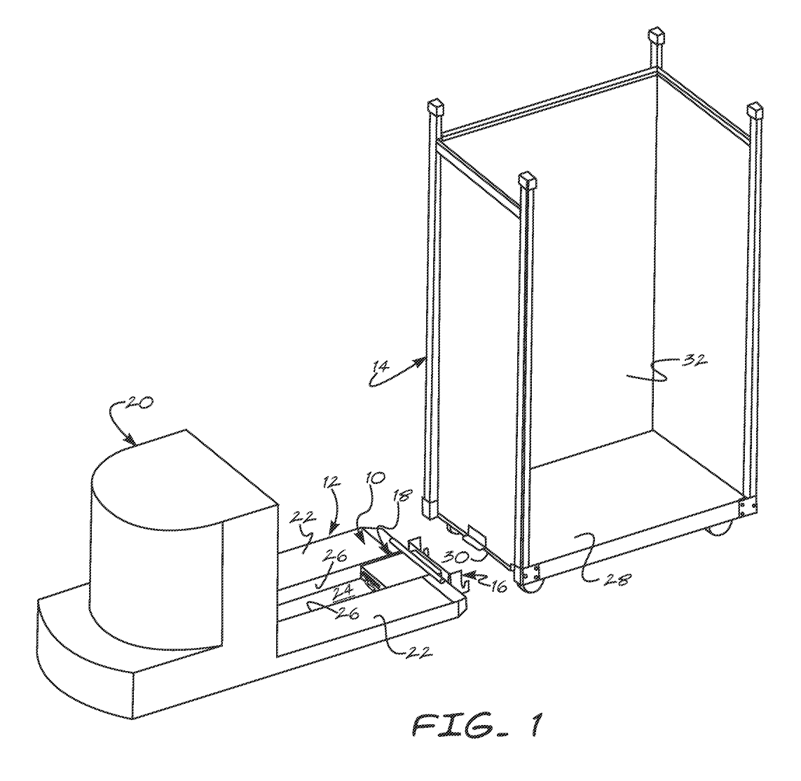

Referring in more detail to the drawings, FIGS. 1-6 show an embodiment of a fork attachment 10 that may be carried by a fork 12 for handling loads like a cart 14. The fork attachment 10 acts as an adaptor, or accessory, to hitch the fork 12 to the cart 14 and to then move the cart 14 to a desired location. A head 16 may be mounted on a body 18 so that the head can rotate, or pivot, and thus orientate itself to a misaligned cart, such as when the cart 14 has an angled base 28 (slanted downward front-to-back) or when the ground beneath the cart is uneven with potholes or slanted. The fork attachment 10 may be mounted to the fork 12 so that the body 18 and head 16 can pivot with respect to the ground when the fork is lowered completely to the ground.

Referring to FIG. 1, the fork 12 may be equipped on a walkie-rider 20 that can engage and move the cart 14 with the fork 12 and the fork attachment 10. The fork 12 may have a pair of parallel prongs 22 that are spaced apart to define an inside spacing 24 extending from one inside wall 26 to another. The cart 14 itself is constructed to hold beverage containers and, accordingly, can have the angled base 28 and an angled lip 30 to help keep the associated containers sloped away from the cart's open face and toward its back wall 32.

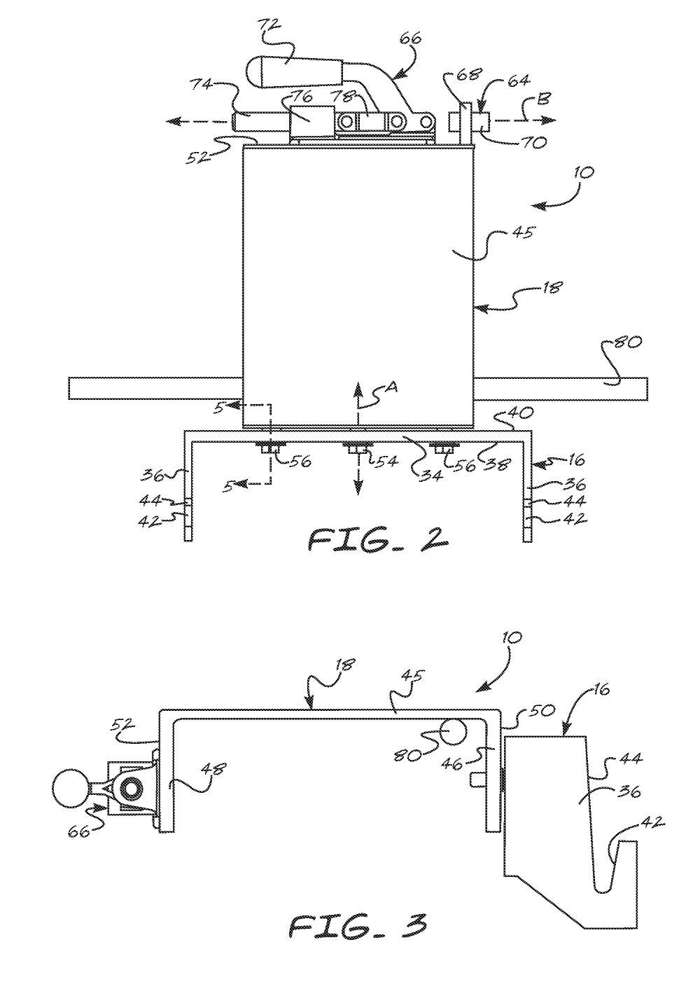

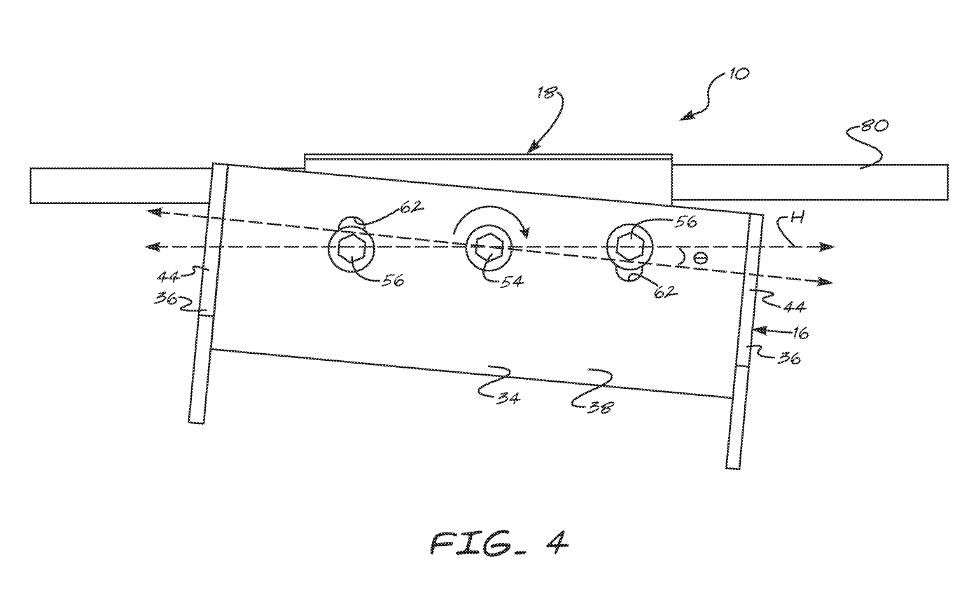

Referring to FIG. 2, the head 16 may be mounted on the body 18 so that the head can rotate about an axis A to define a swivel angle Θ (FIG. 4) with respect to a horizontal axis H. In this way, the head 16 can engage the lip 30 of the cart 14 when the two are misaligned, such as when the lip is angled or when the ground beneath the walkie-rider 20 is uneven by being slanted, having low spots, having potholes, or the like. The head 16 may be made as a single piece or as separate pieces subsequently attached together, and may be constructed of a metal such as aluminum or steel, or a polymeric or composite material, or the like. The head 16 may be located at, and project away from one end of the fork attachment 10. Referring to FIGS. 2-4, in one embodiment of the head 16, a beam 34 may extend between a pair of oppositely disposed hooks 36. The beam 34 constitutes the main structure of the head 16 and has a front surface 38 and a back surface 40. The hooks 36 may project perpendicularly away from opposite ends of the beam 34 and may be the components of the fork attachment 10 that actually engage the cart's base 28. To do so, each hook 36 may define a depression 42 that receives the lip 30 and may form an engagement surface 44 that abuts the base 28. In other embodiments, the head may have a single elongated hook, may have three evenly spaced hooks, or the like.

Referring to FIGS. 2 and 3, the body 18 constitutes the main structure of the fork attachment 10. Like the head 16, the body 18 may be made as a single piece or as separate pieces subsequently attached together, and may be constructed of a metal such as aluminum or steel, or a polymeric or composite material, or the like. In one embodiment of the body 18, a base 45 extends perpendicularly between a front wall 46 and a back wall 48. The front wall 46 has a front surface 50, and the back wall 48 has a back surface 52.

As mentioned, the head 16 can rotate about and with respect to the body 18. Skilled artisans will appreciate that the head 16 can be mounted to the body 18 in a number of ways to achieve rotation, including by use of a first pin 54. Referring to FIGS. 2-4, the first pin 54 may mount the back surface 40 of the head 16 near the front surface 50 of the body 18, and may define the axis A about which the head swivels and rotates. The first pin 54 may be bolted completely through the head 16 and centered between the hooks 36, and bolted through the body 18 as shown. The first pin 54 may be unthreaded with one or more washers (not shown) sitting against the front and back surfaces 38 and 40, and with a bushing (also not shown) fitted in a hole defined in the head 16 that receives the first pin. The bushing provides for smooth rotating movement while the first pin 54 is rigidly fixed in the body 18 and does not itself rotate; in other embodiments, the first pin may rotate with the head.

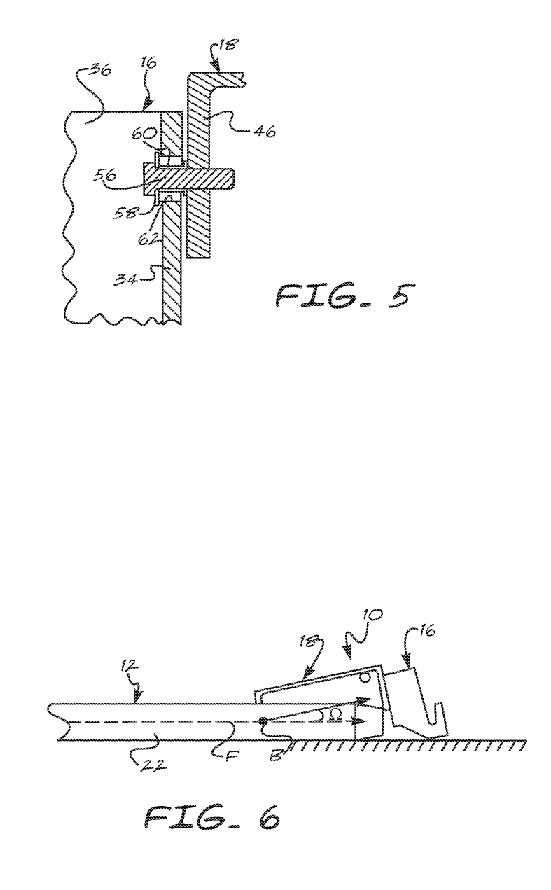

A pair of bolts 56 may help mount the head 16 to the body 18, and may limit the rotating movement of the head 16. These bolts may be bolted completely through the head 16 and through the body 18, and may be located on opposite sides of the first pin 54 to limit the head's rotation in the clockwise and counterclockwise directions (when viewed in front as in FIG. 4). Referring to FIG. 5, each bolt 56 may be partially unthreaded and may have one or more washers 58 and a bushing 60. The bushing 60 may be fitted in a slot 62 which is in the direction of the rotating movement. The slot 62 may be defined in the head 16 and may have a generally kidney-shape (i.e., slightly arcuate) to allow limited clockwise and counterclockwise rotation. The bolts 56 may be rigidly fixed in the body 18 and do not move themselves; in other words, in this embodiment only the head 16 rotates about the axis A. For example, at one extreme shown in FIG. 4, the head 16 may be rotated clockwise to define the swivel angle Θ at about 5° with respect to the horizontal H. This could accommodate the lip 30 if angled at about the same or a lesser degree. Rotated counterclockwise, the head 16 would define another 5° swivel angle that, with the clockwise angle, totals an angle of rotation from one extreme to the other of about 10°. This total angle of rotation can vary somewhat, and may be dictated by factors such as the expected angled base of the cart, the expected degree of unevenness of the ground, and preventing the fork attachment from contacting the ground as a result of too great of a swivel angle. Thus, greater or lesser swivel angles are possible. In other embodiments, a single bolt may be bolted through the head and the body to limit the head's rotating movement in the clockwise and counterclockwise direction in a similar way as explained above.

Referring to FIGS. 2 and 6, in some embodiments the fork attachment 10 may be pivotally attached to the fork 12 to allow the fork attachment 10 to pivot about a pivot axis B and define a pivot angle Ω. Skilled artisans will appreciate that this pivoting can be achieved in a number of ways including, as shown, by a second pin 64 and a clamp 66; or, as not shown, by a pair of oppositely disposed pivot pins, by a single pin, or the like. In any case, the pivot angle Ω may be defined by a fork axis F and a line parallel to the base 45 of the body 18. Naturally, the pivot angle Ω will vary as the body 18 moves about the pivot axis B.

In the embodiment shown, the fork attachment 10 may pivot, or lift up, when the fork 12 is fully lowered and the fork attachment hits the ground. Still, in other embodiments, the fork attachment 10 need not be pivotally attached and instead can be rigidly fixed to the fork's inside edges 26. Referring to FIG. 2, the second pin 64 and the clamp 66 may be mounted on the back surface 52 of the back wall 48. The second pin 64 and the clamp 66 may be constructed to mate with complementary sockets (not shown) provided on each inside wall 26 of the prongs 22 which can be formed by tabs with openings welded to the inside walls 26, or openings machined directly into the inside walls. Skilled artisans will appreciate that the second pin 64 and the clamp 66 may be located and arranged on the body 18 in various ways and locations to accommodate sockets positioned in different ways on the fork 12.

The second pin 64 may be mounted on one side of the back surface 52 by a mount 68 with a pivot pin 70 projecting beyond an edge of the body 45. When inserted in the associated socket, the pivot pin 70 may fit snug in the socket while still being capable of rotating relative to the socket. Similarly, the clamp 66 may fit snug in its associated socket to allow rotation. Suitable clamps may be of the known toggle-lock type such as the 630-R model supplied by the De-sta-co Company headquartered in Auburn Hills, Mich., U.S.A. (www.destaco.com). Skilled artisans will appreciate that other clamps will suffice that can be supplied by different companies or that may even be custom made. As shown, the clamp 66 may include a handle 72 for manually moving a sliding pin 74 back and forth in a barrel 76 to insert the sliding pin 74 in and out of the socket. When clamped down, the sliding pin 74 projects beyond an edge of the body 45. A link 78 may be pivotally attached between the handle 72 and the sliding pin 74 to translate the handle rotation to the linear motion of the sliding pin and thus adjust the clamp 66 between an extended and a retracted position.

A stop 80 may also be included with the fork attachment 10 to prevent the fork attachment from pivoting below the fork axis F about the axis B if the attachment is so pivoted. This limits the fork attachment 10 from pivoting uncontrolled about the axis B. The stop 80 may be designed in a number of ways to limit this pivoting or swinging movement. In the embodiment shown in FIGS. 2-4, the stop 80 may be a cylindrical bar that may be fixed to the bottom of the base 45 by welding, bolting, or the like. On each side, the stop 80 may project beyond an edge of the base 45 so that the stop 80 can rest on top of each prong 22.

To install the fork attachment 10 to the fork 12, the fork attachment may be mounted between the prongs 22 at a free end of the fork so that the head 16 projects out of the spacing 24 and beyond each prong 22. In this way, the head 16 can engage the base 28 without interference from the fork 12.

In use, the head 16 leads the way as the fork 12 approaches the base 28 of the cart 14. If the base 28 is angled, the head 16 can rotate about the axis A to match the base angle so that each hook 36 can hitch to or otherwise engage the lip 30. And if the ground is uneven, and the fork 12 itself is consequently uneven, the head 16 can again rotate to match the lip 30. In either case, it may be the head 16 that rotates relative to the body 18. The fork attachment 10 can then hitch to the base 28 and move the cart 14 to the desired location.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A fork attachment used with a fork of a material handling device to handle a load, the fork attachment comprising:
a body constructed to be carried by the fork; and
a head constructed to engage the load and being mounted to the body so that the head rotates about the body to facilitate engaging the load when the load is initially misaligned with respect to the head.

2. The fork attachment of claim 1 further comprising a first pin that mounts the head to the body so that the head rotates about the first pin and with respect to the body.

3. The fork attachment of claim 2 wherein the body has a back wall, a front wall, and a base extending from the back wall to the front wall, and wherein the first pin goes through the front wall so that the head rotates about the first pin with respect to the front wall.

4. The fork attachment of claim 2 further comprising a pair of bolts that are each bolted to the body and that each extend through a respective slot defined in the head, the pair of bolts limiting the rotating movement of the head about the first pin.

5. The fork attachment of claim 4 wherein the rotating movement of the head is limited by one of the pair of bolts to define a total swivel angle in a clockwise direction with respect to a horizontal of about 5 degrees, and wherein the rotating movement of the head is limited by the other one of the pair of bolts to define a total swivel angle in a counterclockwise direction with respect to the horizontal of about 5 degrees.

6. The fork attachment of claim 1 wherein the body is carried by the fork by being mounted to the fork so that the fork attachment pivots to define a pivot angle with respect to a fork axis.

7. The fork attachment of claim 6 wherein the body has a back wall, a front wall, and a base extending from the back wall to the front wall, and further comprising at least one pin extending from the back wall and mating in a socket defined in the fork so that the fork attachment pivots about the at least one pin.

8. The fork attachment of claim 7 wherein the at least one pin comprises a second pin extending from one side of the back wall to mate in a socket defined in the fork, and also comprises an adjustable clamp extending from another side of the back wall to mate in another socket defined in the fork.

9. The fork attachment of claim 8 further comprising a stop to prevent the fork attachment from pivoting below the fork axis.

10. The fork attachment of claim 9 wherein the stop comprises a bar that is fixed to the base and that projects on each side of the base so that the stop can rest on top of the fork to prevent the fork attachment from pivoting below the fork axis.

11. The fork attachment of claim 1 wherein the head comprises a beam and a pair of hooks extending from the beam to engage the load.

12. A fork attachment carried by a fork of a material handling device to handle a load, the fork attachment comprising:
a body;
at least one pin that mounts the body to the fork and that mates in a socket in the fork so that the fork attachment pivots to define a pivot angle with respect to a fork axis;
a head having at least one hook to engage the load; and
a first pin that mounts the head to the body so that the head rotates about the first pin to define a swivel angle with respect to a horizontal.

13. The fork attachment of claim 12 wherein the body has a base extending from a back wall to a front wall, wherein the at least one pin extends from the back wall, and wherein the first pin mounts the head to the front wall.

14. The fork attachment of claim 12 wherein the at least one pin comprises a second pin extending from the body to mate in the socket in the fork, and comprises a clamp having a sliding pin that adjustably slides away from the body to mate in another socket in the fork.

15. The fork attachment of claim 12 further comprising a stop to prevent the fork attachment from pivoting below the fork axis, the stop having a bar that is fixed to the body and that projects on each side of the body so that the stop can rest on top of the fork to prevent the fork attachment from pivoting below the fork axis.

16. The fork attachment of claim 12 wherein the head comprises a beam and wherein the at least one hook comprises a pair of hooks extending from the beam to engage the load.

17. The fork attachment of claim 12 further comprising a pair of bolts that are each bolted to the body and that each extend through a respective slot defined in the head, the pair of bolts limiting the rotating movement of the head in the clockwise direction with respect to the horizontal and in the counterclockwise direction with respect to the horizontal.

18. A fork attachment comprising:
a body;
at least one pin for mounting the body and for allowing the fork attachment to pivot to define a pivot angle;
a head having at least one hook;
a first pin for mounting the head to the body and for allowing the head to rotate with respect to the body to define a swivel angle;
at least one bolt limiting the rotating movement of the head; and
a stop limiting the pivoting movement of the fork attachment.

19. The fork attachment of claim 18 wherein the body has a base extending from a back wall and to a front wall, wherein the at least one pin comprises a second pin and a clamp, wherein the head has a beam, wherein the at least one hook comprises a pair of hooks extending from the beam, wherein the at least one bolt comprises a pair of bolts that are each bolted to the body and that each extend through a respective slot defined in the head, and wherein the stop has a bar fixed to the body.
